(19) United States
(12) Patent Application Publication
(10) Pub. No.: US 2013/0158864 A1
(43) Pub. Date: Jun. 20, 2013

(54) SYSTEM FOR GUIDING A USER THROUGH A MULTI-OPTION TURN DECISION AND METHOD THEREOF

(71) Applicants: Kyeong Jin Kim, Pohang (KR); Jae Seok Park, Hwaseong (KR)

(72) Inventors: Kyeong Jin Kim, Pohang (KR); Jae Seok Park, Hwaseong (KR)

(73) Assignee: HYUNDAI MOTOR COMPANY, Seoul (KR)

(21) Appl. No.: 13/528,004

(22) Filed: Jun. 20, 2012

(30) Foreign Application Priority Data
Dec. 14, 2011 (KR) 10-2011-0134916

(51) Int. Cl. G01C 21/36

(52) U.S. Cl. 701/428

(57) ABSTRACT

The disclosure provides a system for guiding a user of a vehicle through a multi-option turn decision, and a method using the same. Specifically, the disclosure provides technology for displaying a distance measurement from the current location of a vehicle to all turn options in a region of the vehicle's route guide that has multi-option turn decisions, thereby preventing the user from being confused as to which turn to take.

### CROSS-REFERENCES TO RELATED APPLICATIONS

This application claims priority under 35 U.S.C. §119(a) to Korean patent application No. 10-2011-0134916 filed on Dec. 14, 2011, the disclosure of which is hereby incorporated in its entirety by reference.

### BACKGROUND OF THE INVENTION

1. Field of the Invention

The present invention relates to a navigation system for a vehicle. More particularly, the present invention relates to a navigation system technology for guiding a user accurately through a multi-option turn decision in a driving route between a vehicle's starting point and destination.

2. Description of the Related Art

FIG. 1 illustrates a capture diagram of a guide screen for a multi-option turn choice in a conventional navigation system.

Generally, the navigation system is configured to provide a driving route between the starting point and the destination for a user. In such conventional art navigation systems, it occurs that vehicles are supposed to change their direction such as, for example, by making a right turn or a left turn, or entering an intersection, while driving along the chosen driving route. In this case, the conventional navigation system only displays the remaining distance until the turn to be made by the vehicle (e.g., right turn in 370 meters), as illustrated in FIG. 1 (i.e. turn labeled No. 1). However, a serious problem arises in the case where a second turn choice exists within close proximity , e.g. within 50 meters, to the desired turn choice, as shown in FIG. 1 (i.e. turn labeled No. 2 is very close to turn labeled No. 1). This situation represents a multi-option turn choice. Unfortunately, conventional art navigation system cannot effectively guide users through such a multi-option turn choice by distinguishing whether the right turn to take in 370 m is the first turn or the second turn. Accordingly, there is a need in the are for a navigation system technology that can accurately guide a user through a multi-option turn decision.

### SUMMARY OF THE INVENTION

Various aspects of the present invention have been made in view of the above problems, and provide a system for guiding a user through a multi-option turn decision and a method thereof, which can display a distance measurement from the current location to each possible turn a user may encounter within a predetermined distance from the vehicle while driving, depending on the driving route between a starting point and a destination.

According to an aspect of the present invention, a navigation system for guiding a user through a multi-option turn decision comprises: a driving route providing module configured to provide a driving route depending on a user's starting point and destination; and a display module configured to display the driving route. When a user approaches a multi-option turn decision including a first turn choice and at least one additional turn choice located within a predetermined distance from the first turn choice on the current driving road, the driving route providing module is configured to display a first distance measurement to the first turn choice from the user's current location and a second distance measurement to the second turn choice from the user's current location.

The driving route providing module is configured to display the first distance measurement to be distinguished from the second distance measurement.

The driving route providing module is configured to display the first distance measurement to be distinguished in at least one or more font sizes, colors, or kinds from the second distance measurement.

The driving route providing module includes: a location information checking module configured to check the user's current location; a key input module configured to receive the destination from the user; a map database where map data information is stored; a route guiding module configured to generate a driving route between the user's current location and destination based on the map data so as to create a route guide; and a distance measurement providing module configured to calculate the user's current location, a first distance measurement between the first turn choice and the second turn choice and a second separation distance as a predetermined time interval so as to display a calculation result through a display module.

The first turn choice and the second turn choice may include an intersection turn that varies on the type of intersection . For example, an intersection turn choice may be for a crossroad intersection (e.g. a four way intersection), a multi-road intersection (e.g. a five or six way intersection), or a rotary.

The driving route providing module is configured to display the first distance measurement and the second distance measurement through a first image obtained by enlarging the multi-option turn decision.

The driving route providing module is configured to display the first distance measurement additionally through a second image.

The driving route providing module is configured to display the second distance measurement additionally through a second image.

The system may further comprise a voice guiding module configured to guide the user through the multi-option turn decision by communicating the first distance measurement by voice when the user approaches the multi-option turn decision.

According to another exemplary embodiment of the present invention, a method of guiding a user through a multi-option turn decision comprises: (a) providing a driving route depending on the user's starting point and destination; and (b) when a user approaches a multi-option turn decision including a first turn choice and at least one additional turn choice located within a predetermined distance from the first turn choice on the current driving route, displaying a first distance measurement between the first turn choice and the user's current location and a second distance measurement between the second turn choice and the user's current location.

The step (b) includes displaying the first distance measurement to be distinguished from the second distance measurement.

The step (b) includes displaying the first distance measurement to be distinguished in at least one or more font sizes, colors, or kinds from the second distance measurement.

The step (a) includes: (a-1) checking the user's current location; (a-2) receiving the destination from the user; and (a-3) generating a driving route between the user's current location and destination based on the map data to create a route guide.

The method may further comprise: (c) guiding the first distance measurement by a voice when the user approaches the multi-option turn decision.

According to an exemplary embodiment of the present invention, when a user approaches a multi-option turn decision including a first turn choice and at least one additional turn choice located within a predetermined distance while driving on the driving route on the current driving road, the system is configured to display a first distance measurement between the first turn choice and the user's current location and a second distance measurement between the second turn choice and the user's current location. Thus, the system enables the user to recognize precisely the first turn choice that represents the desired turn planned by the driving route without any confusion.

The system and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 illustrates a capture diagram of a guide screen of a multi-option turn decision in a conventional art navigation system.

FIG. 2 illustrates a block diagram of a system for guiding a user through a multi-option turn decision according to an exemplary embodiment of the present invention.

FIG. 3 illustrates a block diagram of a driving route providing module according to an exemplary embodiment of the present invention.

FIGS. 4 to 6 illustrate screen capture diagrams of a distance measurement providing module for guiding a user through multi-option turn decision with turn choice distance measurements according to an exemplary embodiment of the present invention.

FIGS. 7 and 8 illustrate screen capture diagrams of the distance measurement providing module for guiding a user through a multi-option turn decision with distance measurements through a first image and a second image according to an exemplary embodiment of the present invention.

FIG. 9 illustrates a flow chart of a method of guiding a user along a driving route according to an exemplary embodiment of the present invention.

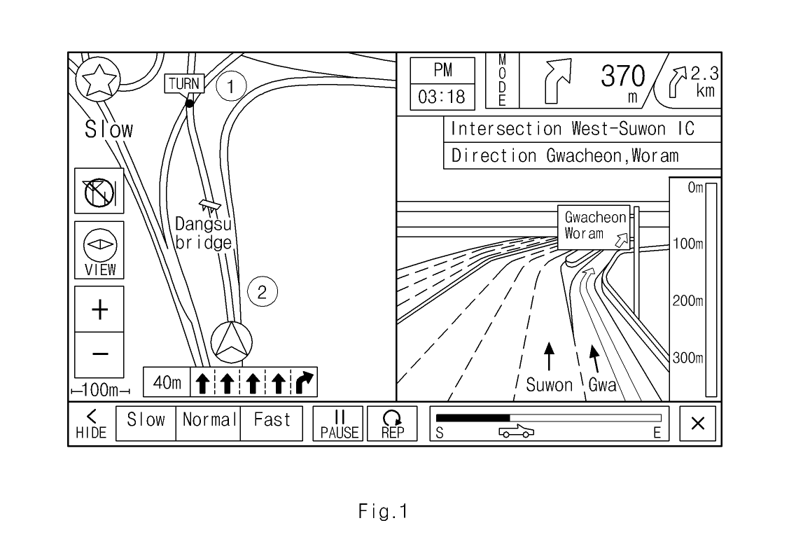

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

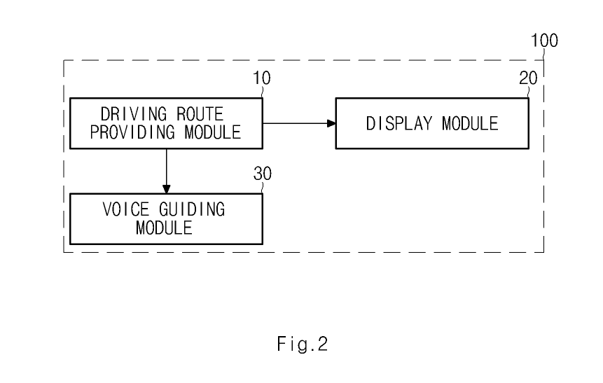

In an aspect of the invention, FIG. 2 illustrates a block diagram of a system 100 for guiding a user through a multi-option turn decision according to an exemplary embodiment of the present invention. As shown in FIG. 2, the system 100 for guiding a multi-option turn decision comprises a driving route providing module 10, a display module 20 and a voice guiding module 30.

The system 100 for guiding a multi-option turn decision is configured to receive a starting point and a destination from a user so as to provide a driving route between the user's starting point and destination based on map data. When the user approaches the multi-option turn decision, the system 100 for guiding a user through a multi-option turn decision displays a first distance measurement to a first turn choice and the user's current location and a second distance measurement to a second turn choice and the user's current location through a display module 20. Here, the multi-option turn decision refers to the turn choices including the first turn choice to enter and at least one additional turn choice located within a predetermined distance from the first block depending on the driving route on the current driving road. It is contemplated within the scope of the invention that the user may configure the predetermined distance.

The display module 20 is configured to display the driving route between the user's starting point and destination based on the map data.

The voice guiding module 30 is configured to recite the first distance measurement by voice when the user approaches the multi-option turn decision.

Hereinafter, components included in the system 100 for guiding a user through a multi-option turn decision will be described in more detail.

Configuration of the Driving Route Providing Module 10

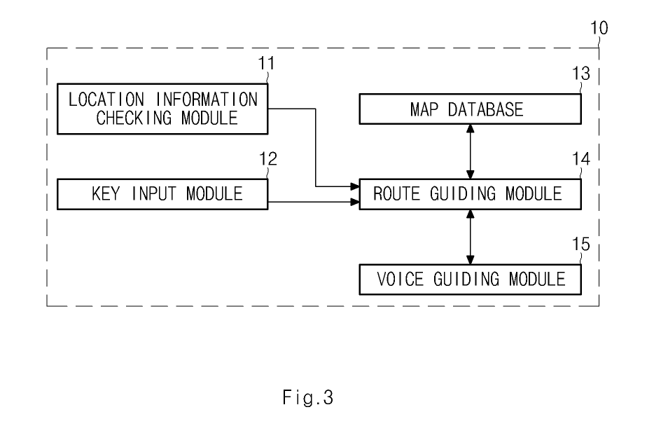

FIG. 3 illustrates a block diagram of the driving route providing module 10 according to an exemplary embodiment of the present invention. As shown in FIG. 3, the driving route providing module 10 includes a location information checking module 11, a key input module 12, a map database 13, a route guiding module 14 and a separation distance providing module 15.

The location information checking module 11 is configured to check the vehicle's current location in each predetermined time interval. Such a location information checking module 11 may be comprised of, for example, location information receiving devices based on the global positioning system (GPS) or the code division multiple access (CDMA), but are not limited thereto.

The key input module 12 may be configured with a key pad or a touch screen. The key input module 12 interlocked with the driving route providing module 10 is configured to provide the input interface that can receive a starting point, a destination, a route, etc. from a user.

In the map database 13, map data including various road information with multi-option turn decisions (such as, e.g., four way intersections, multi-way intersections, merges, junction points, rotaries, etc.) and guide information on various buildings and facilities are stored. In an exemplary embodiment, he map database 13 need not be mounted in the system 100 for guiding a user through a multi-option turn decision, but rather may be included in an additional server terminal. In this exemplary embodiment, the system 100 for guiding a multi-option turn decision may request a driving route between the starting point and the destination from the server and receive the driving route and the map data corresponding to the driving route from the server in a predetermined time interval.

The driving route providing module 10 generates a driving route between the starting point, or the vehicle's current location checked through the location information checking module 11, received through the key input module 12 from the user and the destination (including the route) based on map data using the map database 13. Here, the driving route includes a shortest distance route obtained by a general map matching method (e.g. a direct route), a high speed route (e.g. a maximize freeways route), a public road route (e.g. a minimize toll roads route), a real-time quick route reflecting traffic information, and the like. As mentioned above, when the map database 13 is not mounted in the system 100 for guiding a multi-option turn decision but in the server instead, the driving route providing module 10 does not generate a driving route directly, but may request generation of a driving route between the starting point and the destination to the server through an additional communication module (not shown) and receive the driving route from the server. The driving route providing module 10 can create a general road guide for the user through the generated driving route and the user's current location.

For example, suppose that the driving route includes a first turn choice (e.g., Seocho IC) on a first road (e.g. Gyeongbu Expressway) and multi-option turn decision (e.g., intersection of Seocho IC and a second road Nambusunhwanno). However, suppose that a second turn choice (e.g., Yangjae IC) and a third turn choice (e.g., Banpo IC) connected respectively to a third road and a fourth road, which are adjacent to the first turn choice, are additionally located in the first multi-option turn decision. In this case, in a general road guide, the driving path providing module 10 displays to the user or guides the user by a voice with a distance measurement from the vehicle to the first turn choice of the first multi-option turn decision (e.g. intersection) relative to the current location of the first road where the user is currently driving. Since the second turn choice and the third turn choice are additionally located within the vicinity of the first turn choice, the user may be confused if the correct turn to enter is the second turn choice or the third turn choice.

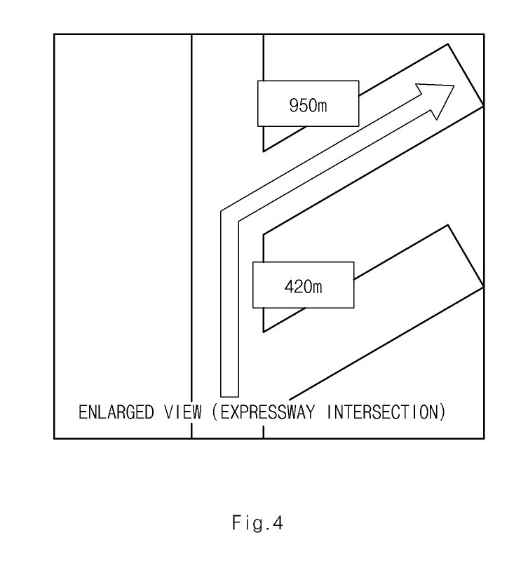

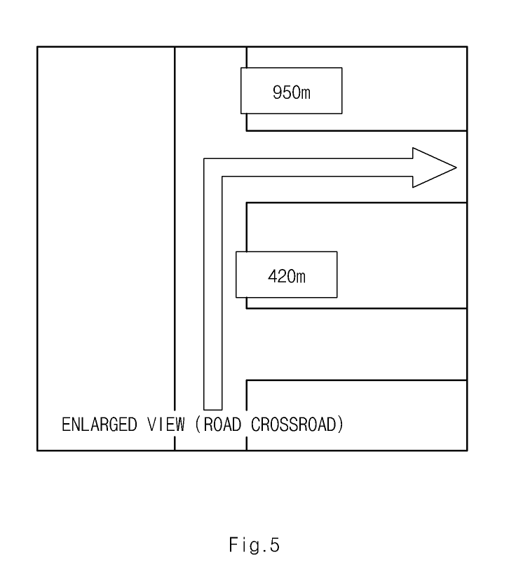

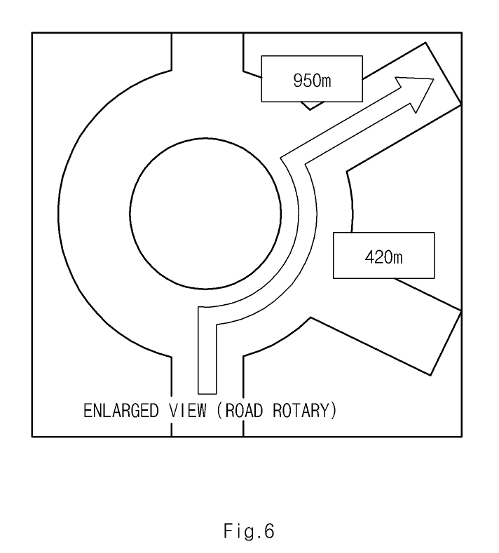

FIGS. 4 to 6 illustrate screen capture diagrams of the distance measurement providing module 15 for guiding a user with a distance measurement of the multi-option turn decision according to an exemplary embodiment of the present invention.

In order to prevent such confusion, when the user approaches a multi-option turn decision including a first turn choice and at least one additional turn choice located (if a predetermined distance exceeds, that turn may not be apply) at a predetermined distance from the first turn choice depending on the driving route on the current driving road, the distance measurement providing module 15 displays a first separation distance (e.g. 950 m) between the first turn choice and the user's current location and a second distance measurement (e.g. 420 m) between the second turn choice and the user's current location. The distance measurement providing module 15 is configured to display the first distance measurement by a different font or color (e.g., yellow) from the second distance measurement to be distinguished in at least one or more of font sizes, colors, or kinds from the second distance measurement. As a result, the user can confirm clearly the correct turn to enter among the various turn choices of the multi-option turn decision.

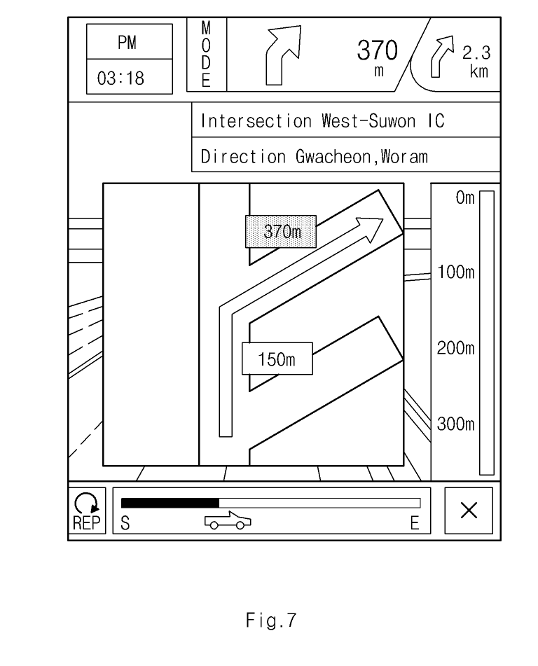

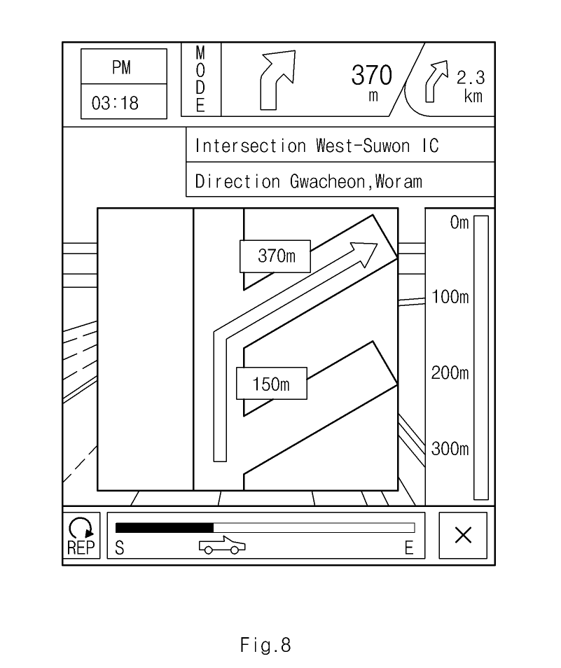

FIGS. 7 and 8 illustrate screen capture diagrams of the distance measurement providing module 15 for guiding a distance measurement for the multi-option turn decision through a first image and a second image according to an exemplary embodiment of the present invention.

The distance measurement providing module 15 may display the first distance measurement and the second distance measurement on a map screen of the display module 20 or through a first image obtained by enlarging the multi-option turn decision region. When the separation distance module 15 displays the first distance measurement and the second distance measurement on the map screen of the display module 20, a distance measurement of the first turn choice may be further displayed through a second image (in a general road guide, a distance measurement display image depending on direction change, see upper 370 m of FIGS. 7 and 8). In this case, the user can confirm simultaneously the distance measurement of the first turn choice checked through the second image with the first distance measurement of the first turn choice and the second distance measurement of the second turn choice displayed through the first image. Although the first separation distance is not displayed with emphasis in comparison of the second distance measurement as shown in FIG. 7 (can be displayed with emphasis as shown in FIG. 8), the user can confirm naturally the first distance measurement of the first image to have the same distance measurement with the distance measurement of the second image.

Configuration of the Display Module 20

As shown in FIG. 2, the display module 20 is configured to display the driving route.

Configuration of the Voice Guiding Module 30

As shown in FIG. 2, the voice guiding module 30 is configured to guide the first distance measurement by a voice when the user approaches the multi-option turn decision.

Hereinafter, the method of guiding a driving route according to an exemplary embodiment of the present invention will be described in detail.

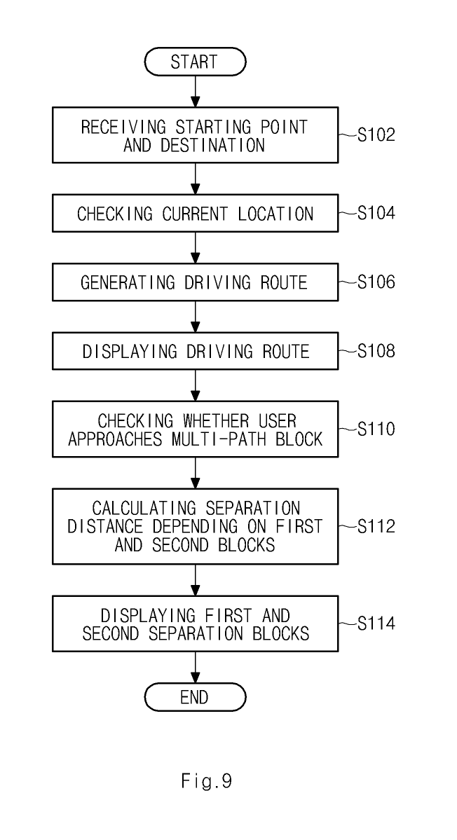

FIG. 9 illustrates a flow chart of a method of guiding a user through a driving route according to an exemplary embodiment of the present invention.

As shown in FIG. 9, the key input module 12 of the driving route providing module 10 receives the starting point and the destination from the user (S100). Then, the location information checking module 11 of the driving route providing module 10 checks the user's current location (S102). Thereafter, the route guiding module 14 of the driving route providing module 10 generates a driving route between the user's current location and the destination based on map data (S104). The route guiding module 14 of the driving route providing module 10 creates a route guide depending on the driving route (S106). Then, the display module 20 displays the driving route (S108). Thereafter, the distance measurement providing module 15 of the driving route providing module 10 checks whether the user approaches a multi-option turn decision including a first turn choice and at least one additional turn choice located within a predetermined distance from the first turn choice depending on the driving route on the current driving road (S110). The sep distance measurement providing module 15 of the driving route providing module 10 calculates a first distance measurement between the first turn choice and the user's current location and a second distance measurement between the second turn choice and the user's current location when the user approaches the multi-path block (S112).

The distance measurement providing module 15 of the driving route providing module 10 displays the first distance measurement between the first turn choice and the user's current location and the second distance measurement between the second turn choice and the user's current location (S114).

As described above, when a user approaches a multi-option turn decision including a first turn choice and at least one additional turn choice located within a predetermined distance while driving on the current driving road, the system according to an exemplary embodiment of the present invention is configured to display a first distance measurement between the first turn choice and the user's current location and a second distance measurement between the second turn choice and the user's current location. Thus, the system enables the user to recognize precisely the first turn choice to drive originally (e.g. the correct turn planned by the driving route) in the multi-option turn decision without any confusion.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or over a Controller Area Network (CAN).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for guiding a user through a multi-option turn decision, comprising:
a driving route providing module configured to provide a driving route depending on the user's starting point and destination; and
a display module configured to display the driving route,
wherein the driving route providing module is configured to display a first distance measurement between a first turn choice and the user's current location and a second distance measurement between a second turn choice and the user's current location when the user approaches a multi-option turn decision comprising a first turn choice and at least one additional turn choice within a predetermined distance from the first turn choice on the current driving route.

2. The system of claim 1, wherein the driving route providing module is configured to display the first distance measurement to be distinguished from the second distance measurement.

3. The system of claim 2, wherein the driving route providing module is configured to display the first distance measurement to be distinguished from the second distance measurement in a different font size, color, highlight, animation, or any combination thereof.

4. The system of claim 1, wherein the driving route providing module comprises:
a location information checking module configured to check the user's current location;
a key input module configured to receive the destination from the user;
a map database where map data information is stored;
a route guiding module configured to generate a driving route between the user's current location and destination based on the map data so as to create a route guide; and
a distance measurement providing module configured to calculate the user's current location, the first distance measurement between the first turn choice and the second turn choice and the second distance measurement as a predetermined time interval so as to display a calculation result on a display module.

5. The system of claim 1, wherein the first turn choice and the second turn choice are selected from the group consisting of four way intersections, multi-way intersections, T intersections, Y intersections, merges, junction points, highway entrance ramps, highway exit ramps, rotaries, and any combination thereof.

6. The system of claim 1, wherein the driving route providing module is configured to display the first distance measurement and the second distance measurement through a first image obtained by enlarging the multi-option turn decision.

7. The system of claim 1, wherein the driving route providing module is configured to display the first distance measurement through a second image.

8. The system of claim 6, wherein the driving route providing module is configured to display the second distance measurement through a second image.

9. The system of claim 1, further comprising a voice guiding module configured to recite the first distance measurement by a voice when the user approaches the multi-option turn decision.

10. A method of guiding a user through a multi-option turn decision, comprising:
(a) providing a driving route depending on the user's starting point and destination; and
(b) displaying a first distance measurement between a first turn choice and the user's current location and a second distance measurement between a second turn choice and the user's current location when the user approaches a multi-option turn decision comprising a first turn choice and at least one additional turn choice within a predetermined distance from the first turn choice.

11. The method of claim 10, wherein the step (b) includes displaying the first distance measurement to be distinguished from the second distance measurement.

12. The method of claim 11, wherein the step (b) includes displaying the first distance measurement to be distinguished from the second distance measurement in a different font size, color, highlight, animation, or any combination thereof.

13. The method of claim 10, wherein step (a) comprises:
(a-1) checking the user's current location;
(a-2) receiving the destination from the user;
(a-3) generating a driving route between the user's current location and destination based on the map data; and
(a-3) creating a route guide.

14. The method of claim 10, further comprising: (c) guiding the first distance measurement by a voice when the user approaches the multi-option turn decision.

15. A non-transitory computer readable medium containing program instructions executed by a processor or controller, the computer readable medium comprising:
program instructions that provide a driving route depending on a user's starting point and destination; and
program instructions that display a first distance measurement between a first turn choice and the user's current location and a second distance measurement between a second turn choice and the user's current location when the user approaches a multi-option turn decision comprising a first turn choice and at least one additional turn choice within a predetermined distance from the first turn choice.

16. The non-transitory computer readable medium of claim 15, further comprising:
program instruction that display the first distance measurement to be distinguished from the second distance measurement in a different font size, color, highlight, animation, or any combination thereof.
